(19) United States
(12) Patent Application Publication
(10) Pub. No.: US 2024/0394854 A1
(43) Pub. Date: Nov. 28, 2024

(54) METHOD AND SYSTEM FOR RECTIFYING IMAGE

(71) Applicant: AJOU UNIVERSITY INDUSTRY-ACADEMIC COOPERATION FOUNDATION, Suwon-si, Gyeonggi-do (KR)

(72) Inventors: Hyung Il KOO, Gyeonggi-do (KR); Gwang Jin KIM, Gyeonggi-do (KR); Dong Won SHIN, Seoul (KR)

(73) Assignee: AJOU UNIVERSITY INDUSTRY-ACADEMIC COOPERATION FOUNDATION, Suwon-si, Gyeonggi-do (KR)

(21) Appl. No.: 18/290,230

(22) PCT Filed: Aug. 3, 2021
(86) PCT No.: PCT/KR2021/010149

§ 371 Date: Aug. 2, 2024

(30) Foreign Application Priority Data
May 10, 2021 (KR) 10-2021-0060064
May 21, 2021 (KR) 10-2021-0065612

(51) Int. Cl. G06T 5/80; G06V 10/98

(52) U.S. Cl. CPC G06T 5/80; G06V 10/993; G06T 2207/20021; G06T 2207/20084

(57) ABSTRACT

An image rectification system according to an aspect of the inventive concept includes: a distortion characteristic estimation module configured to divide an input image into a plurality of cells and estimate a distortion characteristic of each of the plurality of divided cells; a rectification information generation module configured to generate rectification information for each of the plurality of cells based on estimated distortion characteristic and reference information for rectification; and an image conversion configured to obtain a parameter for rectification for each of the plurality of cells and alignment of rectified cells based on the generated rectification information, and perform rectification on the input image based on the obtained parameter.

### CROSS REFERENCE TO RELATED APPLICATIONS

This application is a National Stage of International Application No. PCT/KR2021/010149, filed on Aug. 3, 2021, the contents of which are incorporated herein by reference in their entireties.

### TECHNICAL FIELD

The present invention relates to a method and system for rectifying an image.

### BACKGROUND ART

Recently, cameras are used in various industrial fields, and image recognition technology that recognizes characters or objects in images obtained through cameras is in demand. However, in an image obtained through a camera, distortion may occur due to a positional relationship between the camera and an object or a geometric shape of the object's surface. Because this distortion is a factor that reduces recognition accuracy, a rectification process to remove the distortion included in the image may be necessary before performing image recognition.

Most conventional image rectification methods perform rectification by estimating one distortion characteristic per image, but it is difficult to perform correct rectification when various distortion characteristics exist in the image.

### DESCRIPTION OF EMBODIMENTS

### Technical Problem

The present invention provides a method of rectifying various types of distortion that exist in an image.

### Solution to Problem

According to an aspect of the disclosure, an image rectification system comprises: a distortion characteristic estimation module configured to divide an input image into a plurality of cells and estimate a distortion characteristic of each of the plurality of divided cells; a rectification information generation module configured to generate rectification information for each of the plurality of cells based on estimated distortion characteristic and reference information for rectification; and an image conversion module configured to obtain a parameter for rectification for each of the plurality of cells and alignment of rectified cells based on the generated rectification information, and performing rectification on the input image based on the obtained parameter.

According to an exemplary embodiment, the distortion characteristic estimation module comprises, for each of the plurality of divided cells, a deep learning-based network trained to estimate a polygon representing a distortion characteristic of a cell with one pixel included in the cell as a center.

According to an exemplary embodiment, the reference information comprises vertex coordinates of a reference polygon corresponding to a state in which no distortion exists, and the rectification information generation module generates the rectification information based on a difference between vertex coordinates of the polygon estimated for each of the plurality of cells and the vertex coordinates of the reference polygon.

According to an exemplary embodiment, the rectification information generation module is configured to: when there is information about a focus position of the input image, obtain vertex coordinates of a reference polygon to which an aspect ratio calculated based on the focus position is applied; and generate the rectification information based on a difference between the vertex coordinates of the polygon estimated for each of the plurality of cells and the vertex coordinates of the reference polygon to which the aspect ratio is applied.

According to an exemplary embodiment, the rectification information generation module is configured to: estimate reliability based on a tilt difference between a first side of a first polygon estimated for a first cell from among the plurality of cells and a second side corresponding to the first side from among sides of a second polygon estimated for a second cell corresponding to the first cell from among images obtained by rotating the input image by a preset angle; and determine the first cell as a cell in which a rectification operation will be performed when the estimated reliability is greater than or equal to a reference value, wherein the reliability is higher as the tilt difference is closer to the preset angle.

According to an exemplary embodiment, the image rectification system further comprises a database configured to store the vertex coordinates of the polygon estimated for each of the plurality of cells and the vertex coordinates of the reference polygon. According to an exemplary embodiment, the rectification information comprises a homography matrix, and the image conversion module performs homography conversion on each of the plurality of cells based on a homography matrix of each of the plurality of cells.

According to an exemplary embodiment, the image conversion module, for each of the plurality of homography-converted cells, calculates the parameter for aligning the plurality of cells by deforming the plurality of cells so that adjacent sides contact each other, wherein the parameter comprises a value indicating a position to be moved for rectification of each of pixels of the cells of the input image.

According to an exemplary embodiment, the image conversion module performs rectification on the input image through barycentric conversion using the parameter.

According to an exemplary embodiment, the image conversion module performs low rank texture conversion on a rectified image.

According to an aspect of the disclosure, an image rectification method comprises: dividing an input image into a plurality of cells and estimating a distortion characteristic for each of the plurality of divided cells; generating rectification information for each of the plurality of cells based on estimated distortion characteristic and reference information for rectification; obtaining a parameter for rectification for each of the plurality of cells and alignment of rectified cells based on the generated rectification information; and performing rectification on the input image based on the obtained parameter.

### Advantageous Effects of Disclosure

An image rectification method according to an embodiment of the present disclosure may effectively correct various types of distortion present in an image by estimating distortion characteristics of each area (cell) of an input image and performing rectification for each area according to the estimated distortion characteristics.

In addition, the image rectification method of the present disclosure may provide a more naturally rectified image by obtaining a parameter for aligning rectified cells, performing rectification by applying the obtained parameter to an input image, and applying various conversion techniques.

In addition, the image rectification method of the present disclosure divides an input image into a plurality of areas (cells) and estimates a distortion characteristic for each cell, thereby more accurately detecting the plurality of distortion characteristics existing in the image.

In addition, the image rectification method of the present disclosure may provide a more efficient rectification process by clustering cells or pixels with similar distortion characteristics and performing rectification through homography conversion using a representative homography matrix of the cluster.

Effects according to the inventive concept are not limited to the effects described above, and other effects not described herein may be clearly understood by one of ordinary skill in the art from the following description.

### BRIEF DESCRIPTION OF DRAWINGS

A brief description of each drawing is provided to more fully understand drawings recited in the present disclosure.

FIG. 1 is a schematic view of an image rectification operation using an image rectification system, according to an example embodiment of the present disclosure.

FIG. 2 is a view of a configuration example of a rectification information generation module and an image conversion module included in the image rectification system shown in FIG. 1.

FIG. 3 is a flowchart for schematically explaining an image rectification method, according to an example embodiment of the present disclosure.

FIG. 4 is a flowchart showing a specific embodiment of a distortion characteristic estimation operation and a rectification information obtaining operation shown in FIG. 3.

FIGS. 5 to 8B are exemplary views related to the embodiment shown in FIG. 4.

FIG. 9 is a flowchart showing a specific embodiment of a rectification and optimization operation shown in FIG. 3.

FIGS. 10A to 13 are exemplary views related to the embodiment shown in FIG. 9.

FIG. 14 is a schematic view of an image rectification operation using an image rectification system, according to an example embodiment of the present disclosure.

FIG. 15 is a view of a configuration example of a rectification information generation module included in the image rectification system shown in FIG. 14.

FIG. 16 is a flowchart for schematically explaining an image rectification method, according to an example embodiment of the present disclosure.

FIG. 17 is a flowchart showing a specific embodiment of a distortion characteristic estimation operation and a rectification information obtaining and clustering operation shown in FIG. 16.

FIGS. 18 to 21B are exemplary views related to the clustering operation of FIG. 17.

FIG. 22 is an exemplary view of rectified images provided according to an image rectification method of the present disclosure.

FIG. 23 is a schematic block diagram of a device performing an image rectification method, according to an example embodiment of the present disclosure.

### MODE OF DISCLOSURE

Embodiments according to the inventive concept are provided to more completely explain the inventive concept to one of ordinary skill in the art, and the following embodiments may be modified in various other forms and the scope of the inventive concept is not limited to the following embodiments. Rather, these embodiments are provided so that the present disclosure will be thorough and complete, and will fully convey the scope of the inventive concept to one of ordinary skill in the art.

It will be understood that, although the terms first, second, etc. may be used herein to describe various members, regions, layers, sections, and/or components, these members, regions, layers, sections, and/or components should not be limited by these terms. These terms do not denote any order, quantity, or importance, but rather are only used to distinguish one component, region, layer, and/or section from another component, region, layer, and/or section. Thus, a first member, component, region, layer, or section discussed below could be termed a second member, component, region, layer, or section without departing from the teachings of embodiments. For example, as long as within the scope of the present disclosure, a first component may be named as a second component, and a second component may be named as a first component.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

When a certain embodiment may be implemented differently, a specific process order may be performed differently from the described order. For example, two consecutively described processes may be performed substantially at the same time or performed in an order opposite to the described order.

In the drawings, variations from the illustrated shapes may be expected as a result of, for example, manufacturing techniques and/or tolerances. Thus, embodiments of the inventive concept should not be construed as being limited to the particular shapes of regions illustrated herein but may include deviations in shapes that result, for example, from manufacturing processes. Like reference numerals in the drawings denote like elements, and thus their overlapped explanations are omitted.

As used herein, the term “and/or” includes any and all combinations of one or more of the associated listed items.

Hereinafter, embodiments of the inventive concept will be described in detail with reference to the accompanying drawings.

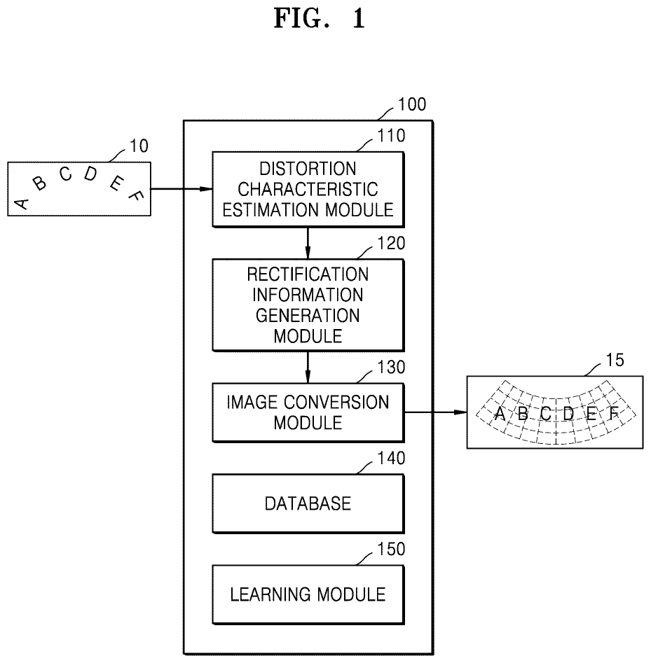

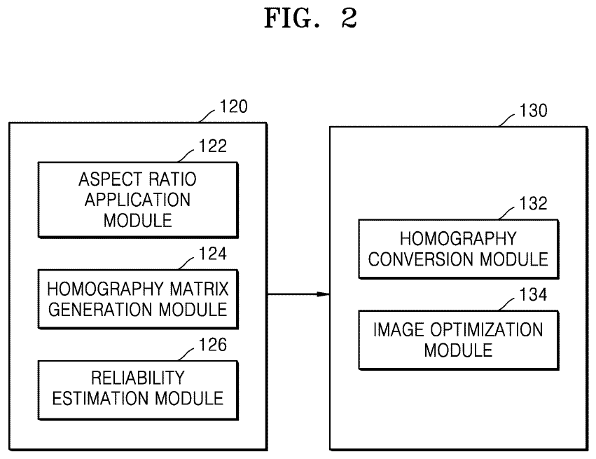

FIG. 1 is a schematic view of an image rectification operation using an image rectification system, according to an example embodiment of the present disclosure. FIG. 2 is a view of a configuration example of a rectification information generation module and an image conversion module included in the image rectification system shown in FIG. 1.

Referring to FIG. 1, an image rectification system 100 according to an embodiment of the present disclosure may estimate a distortion characteristic existing in an input image and provide a rectified image. In particular, even if two or more different types of distortion exist in the input image, the image rectification system 100 according to the present disclosure may effectively provide one rectified image by estimating a characteristic of each distortion.

The image rectification system 100 may include at least one computing device. For example, each of the at least one computing device corresponds to a hardware-based device including a processor, memory, communication interface, input unit, and/or output unit. In this case, components (modules) included in the image rectification system 100 may be implemented as hardware, software, or a combination thereof, and may be implemented by being integrated or divided into the at least one computing device.

The image rectification system 100 according to an embodiment of the present disclosure may include, but is not limited to, a distortion characteristic estimation module 110, a rectification information generation module 120, an image conversion module 130, a database 140, and a learning module 150, and may include more or fewer components.

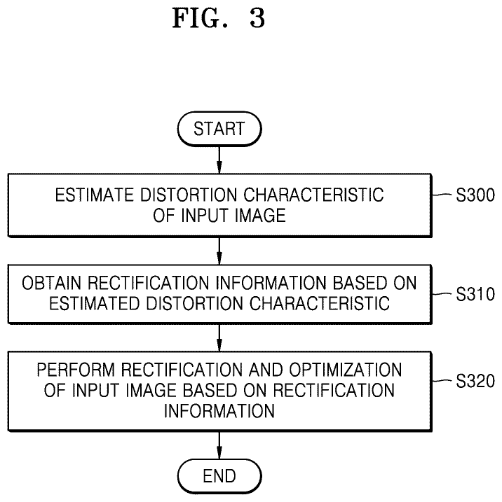

The distortion characteristic estimation module 110 may estimate a distortion characteristic existing in an input image 10. The distortion characteristic may be based on a positional relationship between a camera and an object, or may be based on geometry, deformation, twist, distortion, etc. of the object's surface. The distortion characteristic estimation module 110 according to an embodiment of the present disclosure may estimate various different distortion characteristics existing in the input image 10 by dividing the image 10 into a plurality of cells and estimating a distortion characteristic for each cell. For example, the distortion characteristic estimation module 110 may be implemented to output coordinate information about vertices of a polygon (such as a quadrangle) representing an estimated distortion characteristic. A specific estimation operation of the distortion characteristic estimation module 110 will be described in more detail later with reference to FIGS. 3 to 6.

According to an embodiment, the distortion characteristic estimation module 110 includes a network (artificial neural network) trained based on deep learning, and may estimate a distortion characteristic from the input image 10 using the network. The network may be implemented as a convolutional neural network (CNN), but is not limited thereto. The CNN may be composed of one or more convolutional layers, a pooling layer, and a fully connected layer. The CNN repeats a convolution and pooling process for two-dimensional data such as an image, obtains features (an output feature map) from the data, and performs a classification process using the extracted features to output a result.

The rectification information generation module 120 may generate rectification information for rectifying the input image 10 based on the distortion characteristic estimated by the distortion characteristic estimation module 110.

For example, the rectification information generation module 120 may generate the rectification information based on a difference between information corresponding to the estimated distortion characteristic and reference information for rectification. For example, the information corresponding to the estimated distortion characteristic may include vertex coordinates of a quadrangle indicating distortion characteristics, and the reference information is vertex coordinates of a predefined rectangle (or square) and may correspond to vertex coordinates of a rectified rectangle, that is, a rectangle indicating a state in which no distortion exists. Hereinafter, the ‘rectified rectangle’ will be described as a ‘reference rectangle’.

The image conversion module 130 may provide a rectified image 15 by converting the input image 10 based on the generated rectification information.

A specific implementation example of the rectification information generation module 120 and the image conversion module 130 will be described below with reference to FIG. 2.

Referring to FIG. 2, the rectification information generation module 120 may include an aspect ratio application module 122, a homography matrix generation module 124, and a reliability estimation module 126. According to an embodiment, the aspect ratio application module 122 and/or the reliability estimation module 126 may not be included.

When there is focus position information for the input image 10, the aspect ratio application module 122 may obtain the reference information based on the focus position information. In more detail, the aspect ratio application module 122 may calculate an aspect ratio to be applied to a reference rectangle based on vertex coordinates of a quadrangle representing a distortion characteristic and a focus position of the input image 10, and obtain vertex coordinates (reference information) of the reference rectangle to which the calculated aspect ratio is applied.

When there is no focus position information for the input image 10, the reference information may correspond to vertex coordinates of a reference rectangle with a predefined aspect ratio.

The homography matrix generation module 124 may generate rectification information for rectifying the distortion characteristic based on the distortion characteristic and the reference information. For example, the rectification information may correspond to a homography matrix calculated based on a difference between a quadrangle representing the estimated distortion characteristic and the reference rectangle. The homography matrix corresponds to information for conversion between two images formed based on different viewpoints. According to an embodiment of the present disclosure, when a plurality of different distortion characteristics are estimated from the input image 10, different homography matrices for each of the plurality of distortion characteristics may be generated.

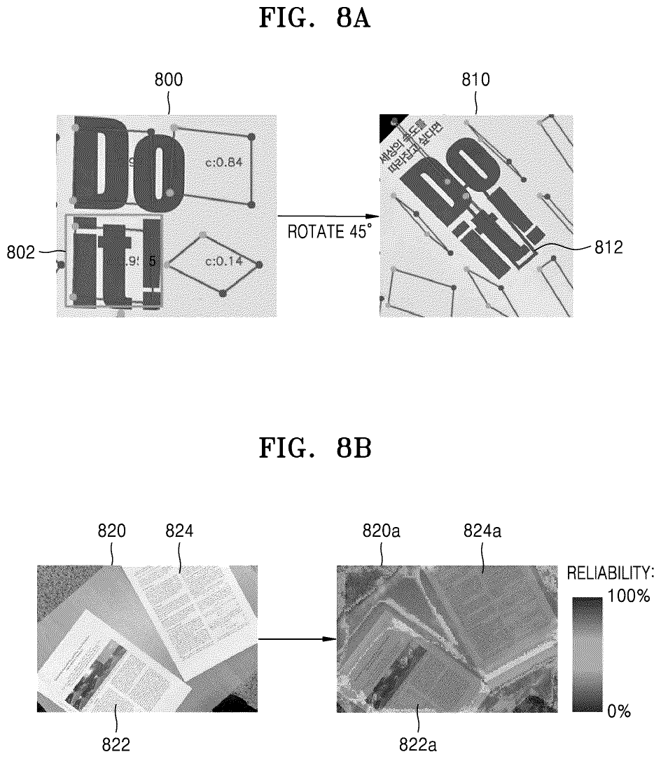

The reliability estimation module 126 may determine whether to perform rectification on a pixel or cell corresponding to the rectification information by estimating reliability of the generated rectification information (e.g., homography matrix). For example, the reliability estimation module 126 may rotate the input image 10 by a certain angle (e.g., 45°, etc.) and estimate a distortion characteristic of the rotated image. Estimation of the distortion characteristic of the rotated image may be performed by the distortion characteristic estimation module 110 or the reliability estimation module 126. The reliability estimation module 126 may estimate reliability based on a difference between a distortion characteristic estimated for the image 10 before rotation and a distortion characteristic estimated for the rotated image. When the estimated reliability is greater than or equal to a reference value, the reliability estimation module 126 may determine to perform rectification on a corresponding pixel or cell, and when the estimated reliability is less than a reference value, the reliability estimation module 126 may determine not to perform rectification on a corresponding pixel or cell. An example related to a specific operation of the reliability estimation module 126 will be described later with reference to FIGS. 8A and 8B.

The image conversion module 130 may include a homography conversion module 132 and an image optimization module 134.

The homography conversion module 132, based on rectification information (homography matrix) for each of cells generated by the rectification information generation module 120, may perform homography conversion on each of the cells. As a result, a distortion characteristic for each of the cells may be eliminated, but separation between the cells may occur due to deformation of the cells.

The image optimization module 134 may estimate or calculate a parameter for aligning cells apart from each other according to homography conversion. For example, the image optimization module 134 may estimate or calculate a parameter related to a position, size, and/or movement of each cell in order to naturally connect the cells apart from each other.

The image conversion module 130 may change pixel values of the input image 10 based on the estimated or calculated parameter and provide the rectified image 15 through a process such as rendering.

Referring again to FIG. 1, the database 140 may be implemented to store data (the vertex coordinates of the quadrangle) representing a distortion characteristic estimated for each of at least some pixels in the input image 10, and reference information (the vertex coordinates of the reference rectangle) for rectifying each of the at least some pixels.

The learning module 150 may perform a learning operation of a network included in the distortion characteristic estimation module 110. The learning module 150 may include an objective function for training the network. For example, the learning module 150 may train the network by changing weights, etc. between nodes included in the network based on a difference between an estimation result of a distortion characteristic for an image for training (an input image, etc.) and correct answer data for the distortion characteristic. ‘Learning’ as used in this specification may have the same meaning as training, and the meaning of performing learning may include both the meaning of a network performing learning or training a network.

Hereinafter, with reference to FIGS. 3 to 13, an image rectification method according to embodiments of the present disclosure will be described in detail.

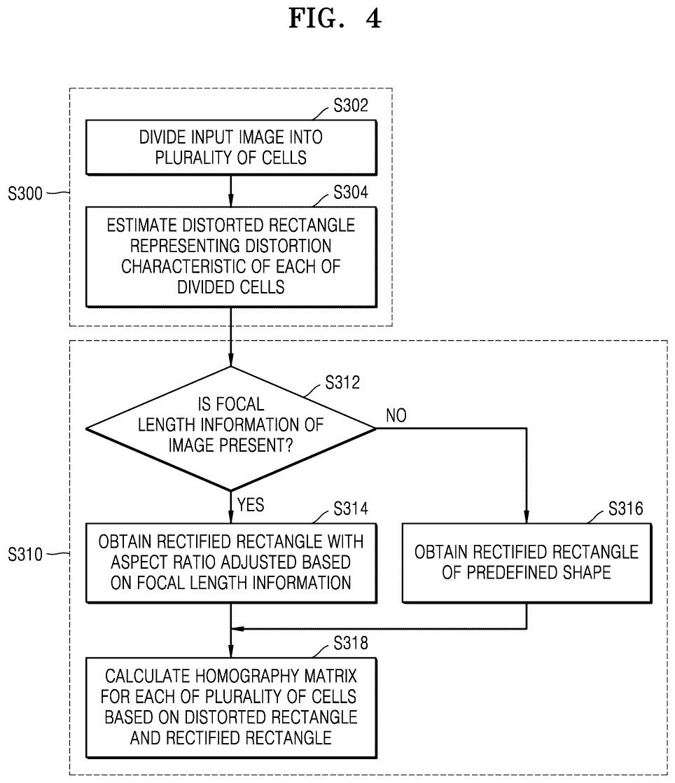

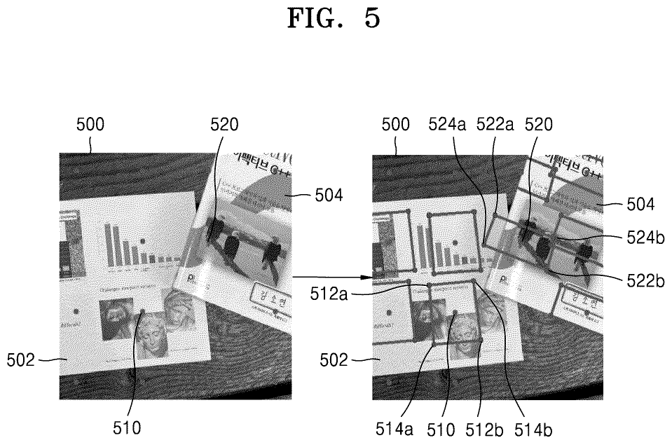

FIG. 3 is a flowchart for schematically explaining an image rectification method, according to an example embodiment of the present disclosure. FIG. 4 is a flowchart showing a specific embodiment of a distortion characteristic estimation operation and a rectification information obtaining operation shown in FIG. 3. FIGS. 5 to 8B are exemplary views related to the embodiment shown in FIG. 4.

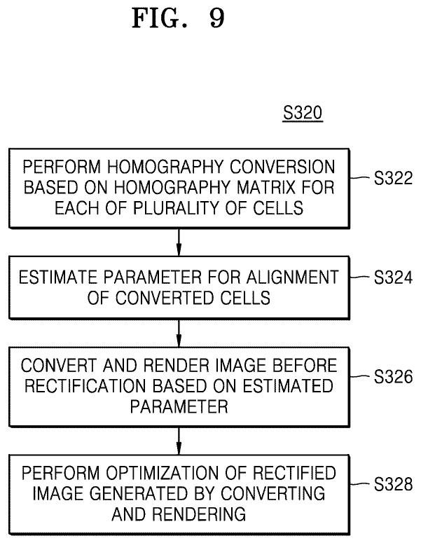

Referring to FIG. 3, the image rectification method according to an embodiment of the present disclosure may include operation S300 of estimating a distortion characteristic of an input image, operation S310 of obtaining rectification information based on the estimated distortion characteristic, and operation S320 of performing rectification and optimization of the input image based on the obtained rectification information. Operation S320 will be described later with reference to FIGS. 9 to 13, and operations S300 to S310 will be described below.

Referring to the embodiments of FIGS. 4 to 6, operation S300 of estimating the distortion characteristic of the input image may include operation S302 of dividing the input image into a plurality of cells and operation S304 of estimating a rectangle (distorted rectangle) representing a distortion characteristic of each of the divided cells.

Referring to FIG. 5, an input image 500 may include a first area 502 rotated counterclockwise by a first angle and a second area 504 rotated clockwise by a second angle. In this case, rectification of the input image 500 may include a process of rotating the first area 502 clockwise by a first angle, and rotating the second area 504 counterclockwise by a second angle. That is, because distortion characteristics of pixels included in the first area 502 and pixels included in the second area 504 are different from each other, there is a need to accurately estimate each distortion characteristic.

To this end, the distortion characteristic estimation module 110 may be implemented to divide the input image 500 into a plurality of cells and estimate a distortion characteristic for each cell. Because respective sizes of the plurality of cells may be set in various ways, a case where a cell includes only one pixel may also be included. In more detail, the distortion characteristic estimation module 110 may include a network (a deep learning-based artificial neural network) trained to divide the input image 500 into a plurality of cells and estimate a quadrangle representing a distortion characteristic of each cell with one pixel 510 or 520 (e.g., a pixel located at a center location or at a predefined location within a cell, etc.) from among pixels included in each cell as a center.

In more detail, the distortion characteristic estimation module 110 (or the network) may estimate a quadrangle showing a distortion characteristic by fixing two vertices (512a and 512b) and (522a and 522b) that are symmetrical around the pixels 510 and 520 and estimating the remaining two vertices (514a and 514b) and (524a and 524b). As shown in FIG. 5, a quadrangle estimated for the pixel 510 present in the first area 502 may correspond to a distortion characteristic of the first area 502, and a quadrangle estimated for the pixel 520 existing in the second area 504 may correspond to a distortion characteristic of the second area 504. According to an embodiment, a quadrangle representing a distortion characteristic of each of cells may be obtained based on quadrangles (mean, median, mode, etc. of corresponding vertices) estimated from each of a plurality of pixels included in a cell.

A straight line connecting the two fixed vertices (512a and 512b) and (522a and 522b) may correspond to a diagonal line of the estimated quadrangle. The distortion characteristic estimation module 110 may fix the two vertices (512a and 512b) and (522a and 522b) so that the diagonal line forms a preset first angle (e.g., 45°, etc.) with respect to the horizon, and obtain the remaining two vertices (514a and 514b) and (524a and 524b) according to a result of the estimating of a quadrangle showing a distortion characteristic.

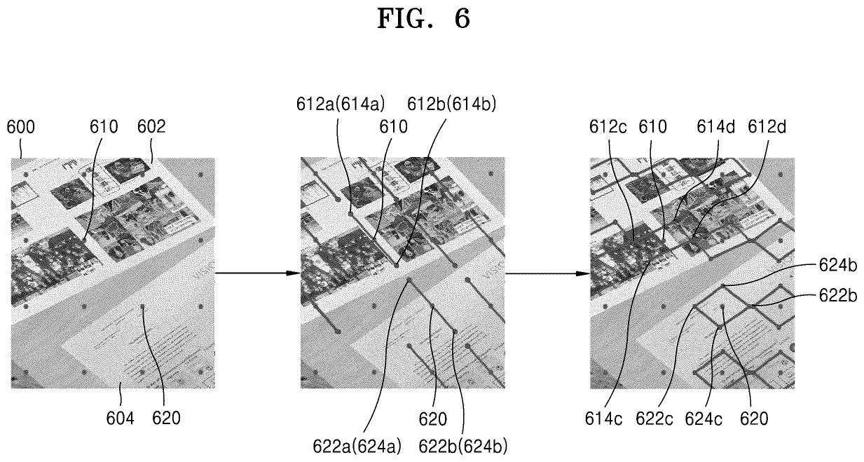

Referring to the embodiment of FIG. 6, it is assumed that a first area 602 of an input image 600 has a distortion characteristic in a form rotated at an angle equal to the preset first angle and a second area 604 has a distortion characteristic in a form rotated at an angle similar to the preset first angle. In this case, two vertices 612a and 612b fixed to a first pixel 610 and remaining two vertices 614a and 614b obtained as a result of estimation of distortion characteristics may be located at the same point. In addition, two vertices 622a and 622b fixed to a second pixel 620 and remaining two vertices 624a and 624b obtained as a result of estimation of distortion characteristics may be close to each other within a certain distance. In this case, a problem may arise in which a quadrangle with four vertices does not accurately express a distortion characteristic.

To solve the problem described above, when the two fixed vertices and the remaining two vertices are close to each other within a certain distance, the distortion characteristic estimation module 110 may change positions of the two fixed vertices and then re-estimate the remaining two vertices. The distortion characteristic estimation module 110 may fix two vertices (612c and 612d) and (622c and 622d) so that a straight line connecting the two vertices forms a preset second angle (e.g., 0°, etc.) with respect to the horizon, and estimate remaining two vertices (614c and 614d) and (624c and 624d) based on distortion characteristics.

The database 140 may store rectangular vertex coordinates estimated for each of at least some of pixels of an input image. The at least some pixels may refer to one pixel 510 or 520 of the respective pixels of the plurality of cells, but may include all pixels of an input image according to an embodiment.

Referring again to FIG. 4, operation S310 of obtaining rectification information based on the estimated distortion characteristic, when there is information about a focal length (or focus position) of the input image (YES in S312), may include operation S314 of obtaining a rectified rectangle (reference rectangle) with an aspect ratio adjusted based on the information.

However, when there is no information about a focal length (or focus position) of the image (NO in S312), in operation S316, a rectified rectangle (reference rectangle) of a predefined shape may be obtained.

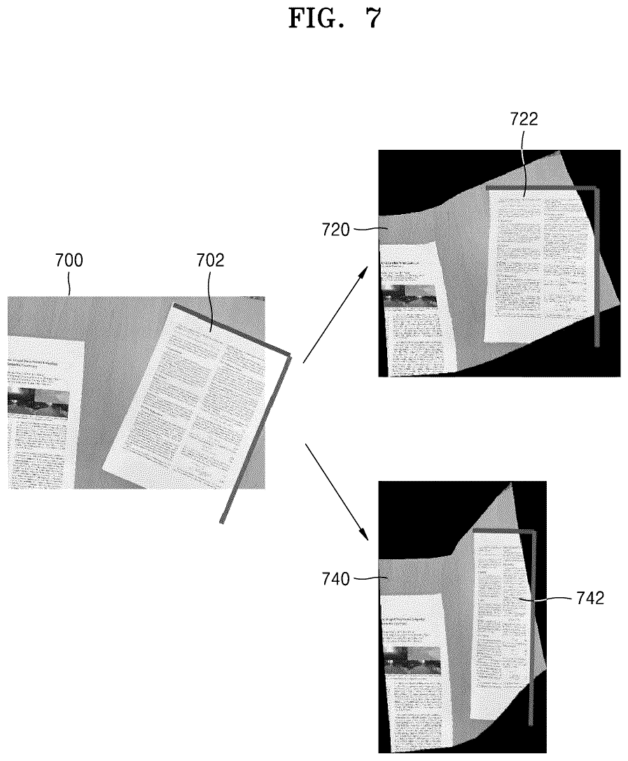

Referring to FIG. 7 together, when there is information about a focus position of an input image 700, the aspect ratio application module 122 may calculate an aspect ratio to be applied to a reference rectangle using rectangular vertex coordinates and a focus position representing a distortion characteristic estimated by the distortion characteristic estimation module 110. The aspect ratio application module 122 may obtain vertex coordinates of the reference rectangle to which the calculated aspect ratio is applied.

When a reference rectangle to which an aspect ratio is applied is obtained, a rectified image 720 may be provided to have an aspect ratio similar to that of the input image. However, when a reference rectangle of a predefined shape without an aspect ratio is obtained, there is a possibility that a rectified image 740 is provided to have an aspect ratio different from that of the input image 700. As shown in FIG. 7, it can be seen that a first area 722 of the rectified image 720, which has been rectified using the reference rectangle to which an aspect ratio is applied, has an aspect ratio similar to that of a first area 702 of the input image 700. However, it can be seen that a first area 742 of the rectified image 740, which has been rectified using the reference rectangle of a predefined shape, has an aspect ratio different from that of the first area 702 of the input image 700.

Continuing to refer to FIG. 4, in operation S318, the image rectification method may calculate a homography matrix for each of a plurality of cells based on a rectangle (distorted rectangle) representing a distortion characteristic and a rectified rectangle (reference rectangle).

As described above in FIGS. 1 and 2, the homography matrix generation module 124 may calculate a homography matrix based on a difference between a quadrangle representing an estimated distortion characteristic and the reference rectangle for each of a plurality of cells.

According to an embodiment, the reliability estimation module 126 may distinguish between cells that will perform rectification and cells that will not perform rectification from among a plurality of cells by estimating reliability of the calculated homography matrix.

In this regard, referring to FIG. 8A, the reliability estimation module 126 may compare a distortion characteristic estimated for an input image 800 with a distortion characteristic estimated from an image 810 obtained by rotating the input image 800 by a certain angle (e.g., 45°).

The reliability estimation module 126 may compare a first quadrangle 802 representing a distortion characteristic estimated for a certain position (cell or pixel) of the input image 800 with a second quadrangle 812 representing a distortion characteristic estimated for a corresponding position (cell or pixel) of the image 810 rotated by a certain angle. Information about the second quadrangle 812 may be obtained by the distortion characteristic estimation module 110 or the reliability estimation module 126.

The reliability estimation module 126 may estimate that the reliability is higher as a tilt difference between one side of the first quadrangle 802 and a corresponding side of the second quadrangle 812 is closer to the certain angle (e.g., 45°), and may estimate that the reliability is lower as the tilt difference is farther from the certain angle (e.g., 45°).

According to the method described above, as shown in FIG. 8B, the reliability estimation module 126 may estimate reliability for each of pixels or cells of an image 820. Referring to a reliability estimation result 820a, pixels (or cells) located in areas 822 and 824 where text exists may have high reliability, and pixels (or cells) located in an area where text does not exist may have relatively low reliability. Based on the reliability estimation result, the image rectification system 100 may improve the efficiency of image rectification by performing a rectification operation only on pixels (or cells) in which the reliability is greater than a reference value.

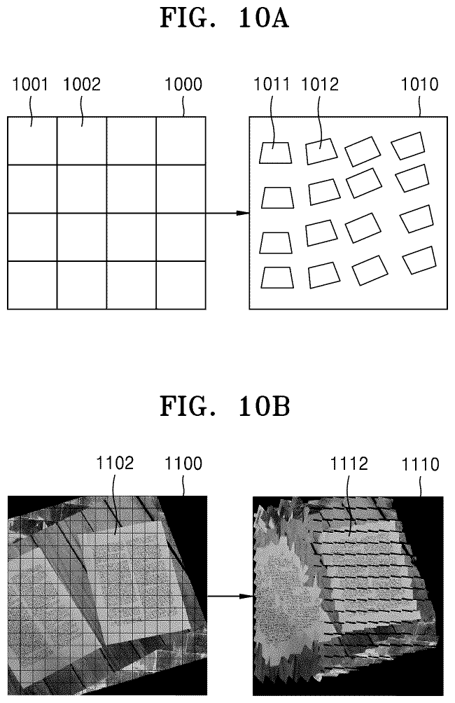

FIG. 9 is a flowchart showing a specific embodiment of a rectification and optimization operation shown in FIG. 3. FIGS. 10A to 13 are exemplary views related to the embodiment shown in FIG. 9.

Referring to FIGS. 3 and 9, in operation S320, the image rectification method may perform rectification and optimization of the input image based on the obtained rectification information (homography matrix).

In more detail, operation S320 may include operation S322 of performing homography conversion based on a homography matrix for each of the plurality of cells, operation S324 of estimating a parameter for alignment of converted cells, operation S326 of converting and rendering an image (an input image) before rectification based on the estimated parameter, and operation S328 of performing optimization of an rectified image generated by converting and rendering.

Referring to FIG. 10A, the homography conversion module 132 may perform homography conversion on each of a plurality of cells 1000 based on a homography matrix generated for each of the cells 1000. As a result of performing homography conversion, distortion of a partial image corresponding to each of the cells 1000 may be removed, but separation and/or overlap may occur due to deformation of the cells. A first cell 1001 and a second cell 1002 are connected to each other before homography conversion, so there is no separation or overlap. However, separation and/or overlap may occur due to deformation between a first cell 1011 and a second cell 1012 on which homography conversion has been performed.

Looking at an example of an actual image with reference to FIG. 10B, cells included in a first area 1102 of an input image 1100 may have distortion characteristics in a form rotated at a certain angle counterclockwise. Because homography conversion is performed on the cells included in the first area 1102, distortion of each cell may be removed, but because separation and/or overlap with adjacent cells occurs, an entire image 1110 may be unnatural.

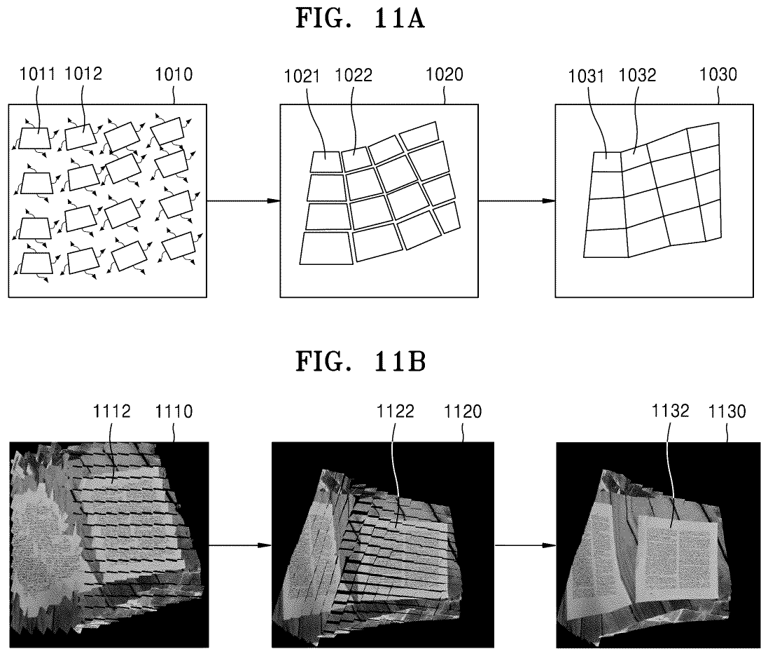

Referring to FIG. 11A, the image optimization module 134 may estimate or calculate a parameters for alignment of spaced and/or overlapping cells according to homography conversion. For example, when cells 1010 become closer to each other within a certain distance, the image optimization module 134 may perform non-rigid conversion to move the cells 1010 to remove overlap between the cells 1010. A distance between a first cell 1021 and a second cell 1022 aligned through non-rigid conversion may be less than a distance between the first cell 1011 and the second cell 1012 before movement.

Adjacent sides of the first cell 1021 and the second cell 1022 may not contact each other. For example, a right side of the first cell 1021 and a left side of the second cell 1022 are supposed to be in contact with each other when the first cell 1021 is connected to the second cell 1022, but lengths and/or tilts of the sides may be different. Therefore, the image optimization module 134 may calculate vertex coordinates of adjacent cells to naturally connect the cells by allowing vertices of the adjacent cells to contact each other. Because cells 1030 are moved and deformed according to the calculated vertex coordinates, separation (a space between a first cell 1031 and a second cell 1032, etc.) between the cells may be eliminated, thereby enabling natural connection.

Referring to FIG. 11B, as described above, when non-rigid conversion is performed on the homography converted image 1110, cells existing in a first area 1122 of an image 1120 on which non-rigid conversion was performed may be aligned without overlapping within a certain distance. When the image optimization module 134 calculates vertex coordinates that allow respective vertices of the cells to contact each other, a more naturally connected image 1130 may be provided by deforming cells based on the calculated vertex coordinates. Accordingly, it can be seen that distortion in a first area 1132 of the image 1130 is removed through rectification.

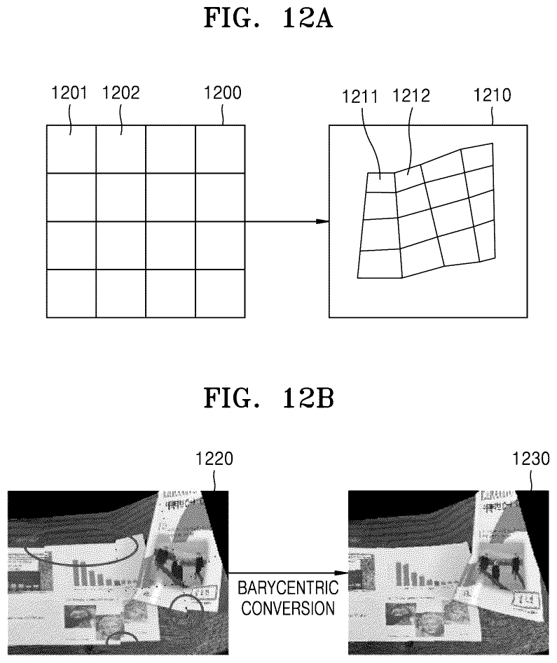

Referring to FIG. 12A, according to the process of FIGS. 10A through 11B, vertex coordinates of cells 1200 before rectification and vertex coordinates of cells 1210 after rectification and alignment may be obtained. Based on this, the image optimization module 134 may calculate a parameter for each cell. The parameter may include values for positions (abscissa and ordinate) to be moved for rectification and/or sizes of the cells for each pixel of cells in an image before rectification.

The image conversion module 130 may perform conversion and rendering operations to obtain a rectified image from an input image based on the obtained parameter. As shown in FIG. 12B, when homography conversion is performed for each cell based on the parameter, it may be unnatural, such as disconnection between textures at the boundaries between cells of a rectified image 1220. To solve this problem, the image conversion module 130 may perform conversion according to a method to rectify the input image more naturally, based on the obtained parameter. For example, the image conversion module 130 may obtain a more naturally connected image 1230 by converting the input image according to barycentric conversion using the center of gravity obtained from vertex coordinates of each rectified cell and then rendering the input image.

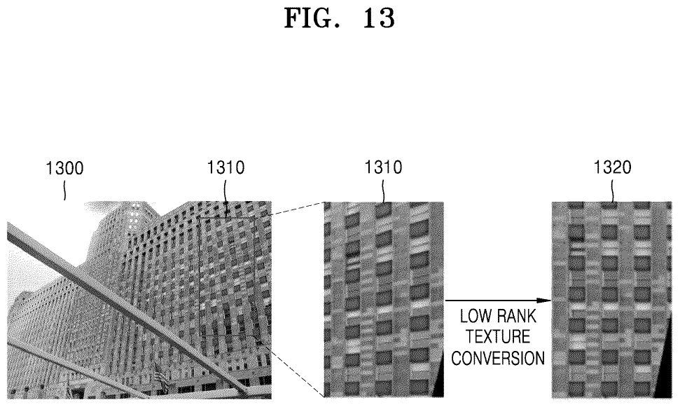

Referring to FIG. 13, because an image 1300 which is converted and rendered has been rectified based on estimation of a distortion characteristic, incomplete rectification may be performed in a partial area 1310. In order to remove the incomplete rectification, the image conversion module 130 may additionally perform a process of converting the converted and rendered image 1300 into a low rank texture. Low rank texture conversion means converting the image 1300 by obtaining textural and geometric information from a two-dimensional image. The obtained information may include not only a local structure such as an edge, but also a regular and symmetrical pattern within the image.

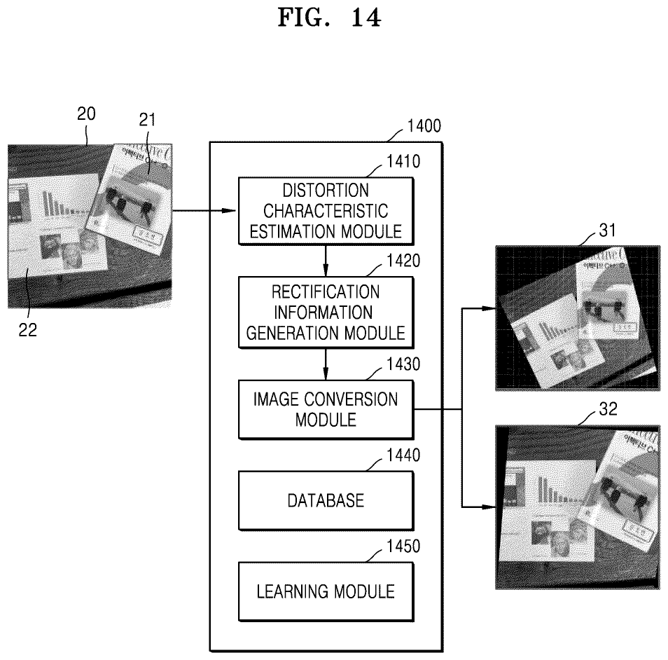

Hereinafter, with reference to FIGS. 14 to 22, an image rectification method according to another embodiment of the present disclosure will be described.

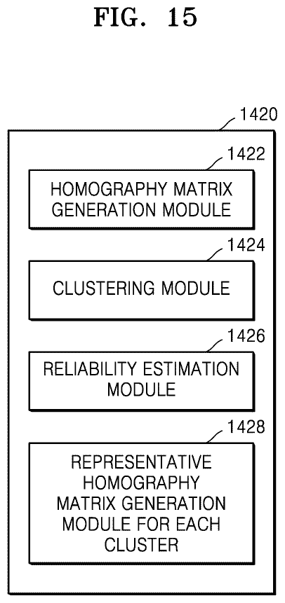

FIG. 14 is a schematic view of an image rectification operation using an image rectification system, according to an example embodiment of the present disclosure. FIG. 15 is a view of a configuration example of a rectification information generation module included in the image rectification system shown in FIG. 14.

Referring to FIG. 14, an image rectification system 1400 according to an embodiment of the present disclosure may estimate a distortion characteristic existing in an input image and provide a rectified image. In particular, even if two or more different types of distortion exist in the input image, the image rectification system 1400 according to the present disclosure may effectively provide rectified images by estimating characteristics of each distortion.

Like the image rectification system 100 described above in FIG. 1, the image rectification system 1400 may include at least one computing device. For example, each of the at least one computing device corresponds to a hardware-based device including a processor, memory, communication interface, input unit, and/or output unit. In this case, components (modules) included in the image rectification system 1400 may be implemented as hardware, software, or a combination thereof, and may be implemented by being integrated or divided into the at least one computing device.

The image rectification system 1400 according to an embodiment of the present disclosure may include, but is not limited to, a distortion characteristic estimation module 1410, a rectification information generation module 1420, an image conversion module 1430, a database 1440, and a learning module 1450, and may include more or fewer components.

The distortion characteristic estimation module 1410 may estimate a distortion characteristic existing in an input image 20. The distortion characteristic may be based on a positional relationship between a camera and an object, or may be based on geometry, deformation, twist, distortion, etc. of the object's surface. The distortion characteristic estimation module 1410 according to an embodiment of the present disclosure may estimate various different distortion characteristics existing in the input image 20 by dividing the image 20 into a plurality of cells and estimating a distortion characteristic for each cell. Taking the image 20 shown in FIG. 14 as an example, it can be seen that a distortion characteristic of a first area 21 and a distortion characteristic of a second area 22 are different. Among the plurality of divided cells, distortion characteristics of the cells included in the first area 21 may correspond to the distortion characteristic of the first area 21, and distortion characteristics of cells included in the second area 22 may correspond to the distortion characteristic of the second area 22.

For example, the distortion characteristic estimation module 1410 may be implemented to output vertex coordinate information of a polygon (such as a quadrangle) representing an estimated distortion characteristic. Because a specific estimation operation of the distortion characteristic estimation module 1410 has been described in detail with reference to FIGS. 5 and 6, redundant description thereof will not be given herein.

Like the distortion characteristic estimation module 110 of FIG. 1, the distortion characteristic estimation module 1410 includes a network (artificial neural network) trained based on deep learning, and may estimate a distortion characteristic from the input image 20 using the network.

The rectification information generation module 1420 may generate rectification information for rectifying the input image 20 based on the distortion characteristic estimated by the distortion characteristic estimation module 1410. The basic content of the rectification information generation module 1420 may be substantially the same as the content of the rectification information generation module 120 of FIG. 1.

The image conversion module 1430 may provide rectified images 31 and 32 by converting the input image 20 based on the generated rectification information.

A specific implementation example of the rectification information generation module 1420 and the image conversion module 1430 will be described below with reference to FIG. 15.

Referring to FIG. 15, the rectification information generation module 1420 may include a homography matrix generation module 1422, a clustering module 1424, a reliability estimation module 1426, and a representative homography matrix generation module for each cluster 1428.

The homography matrix generation module 1422 may generate rectification information for rectifying the distortion characteristic based on the distortion characteristic and the reference information. For example, the rectification information may correspond to a homography matrix calculated based on a difference between a quadrangle representing the estimated distortion characteristic and the reference rectangle. The homography matrix corresponds to information for conversion between two images formed based on different viewpoints. According to an embodiment of the present disclosure, when a plurality of different distortion characteristics are estimated from the input image 20, different homography matrices for each of the plurality of distortion characteristics may be generated.

The clustering module 1424 may cluster cells (or pixels) based on the similarity (or dissimilarity) of respective homography matrices of cells (or pixels) generated by the homography matrix generation module 1422.

The reliability estimation module 1426, by estimating reliability of the generated rectification information (e.g., homography matrix), may determine whether to perform rectification on a pixel or cell corresponding to the rectification information. The reliability estimation module 1426 is substantially the same as the reliability estimation module 126 of FIG. 2, and an example related to a specific operation has been described above in FIGS. 8A and 8B.

The representative homography matrix generation module for each cluster 1428 may generate a representative homography matrix for each of clusters classified by the clustering module 1424. For example, the representative homography matrix may be generated based on an average value, mode, median, etc. of homography matrices of cells (pixels) included in a cluster.

According to an embodiment, the representative homography matrix generation module for each cluster 1428 may generate a representative homography matrix only for a cluster in which reliability estimated by the reliability estimation module 1426 is equal to or greater than a reference value.

Referring again to FIG. 14, the image conversion module 1430 may provide the rectified images 31 and 32 by performing homography conversion on the input image 20 based on a generated representative homography matrix. For example, when there are multiple representative homography matrices, the image conversion module 1430 may provide the plurality of rectified images 31 and 32 by performing homography conversion on the image 20 using each of a plurality of representative homography matrices. Therefore, the image conversion module 1430 may provide the rectified images 31 and 32 for the distorted areas 21 and 22 in the input image 20, respectively. The first image 31 may correspond to a rectified image of the first area 21, and the second image 32 may correspond to a rectified image of the second area 22.

Because the database 1440 and the learning module 1450 are substantially the same as the database 140 and the learning module 150 described above in FIG. 1, a description thereof will not be given herein.

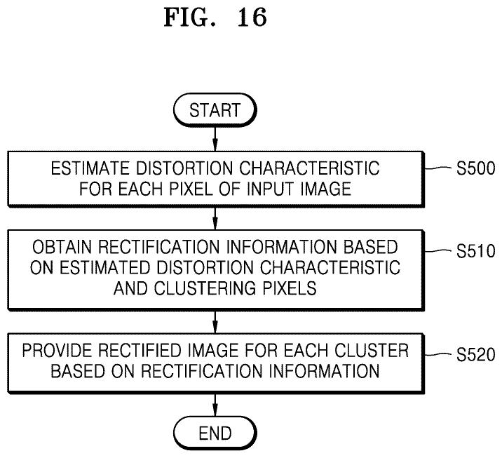

Hereinafter, with reference to FIGS. 16 to 22, an image rectification method according to embodiments of the present disclosure will be described in detail.

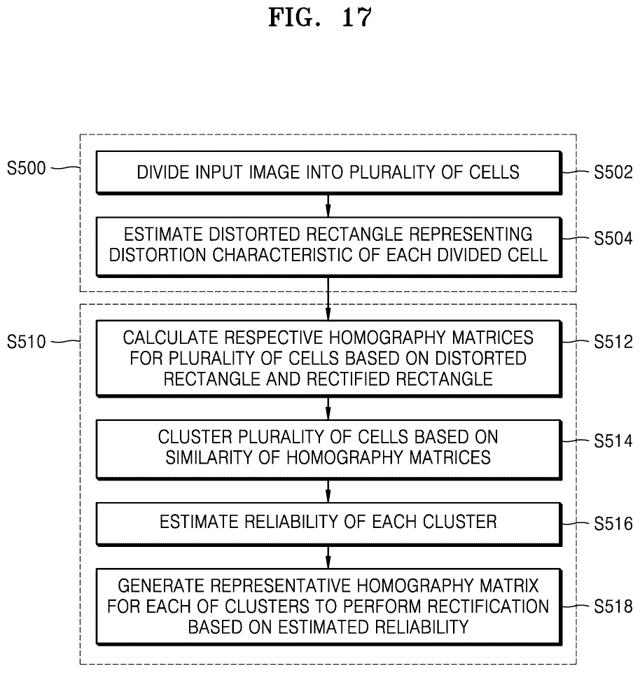

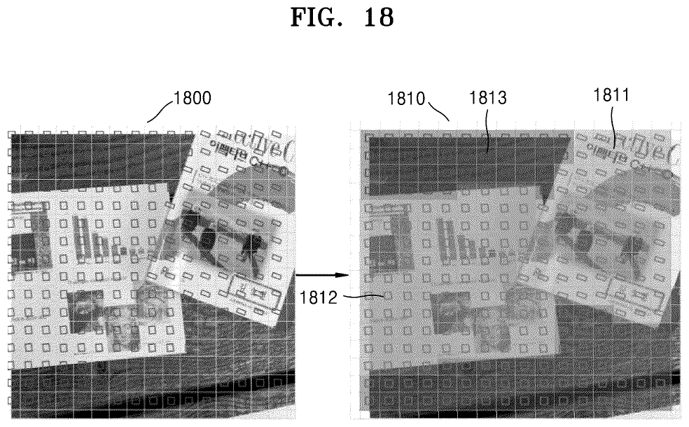

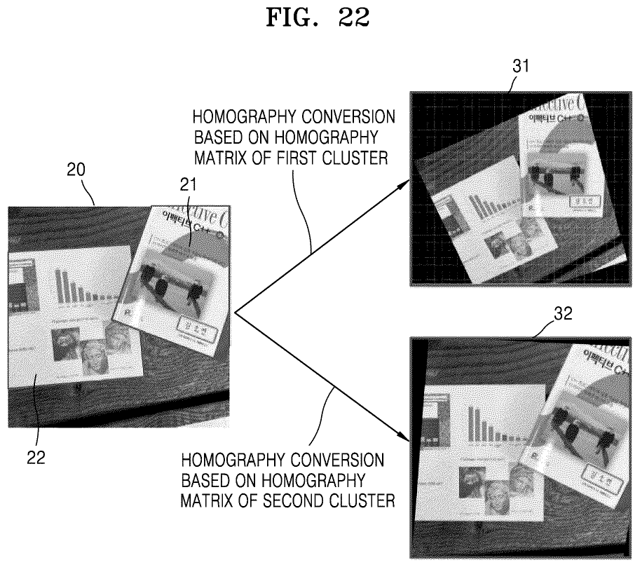

FIG. 16 is a flowchart for schematically explaining an image rectification method, according to an example embodiment of the present disclosure. FIG. 17 is a flowchart showing a specific embodiment of a distortion characteristic estimation operation and a rectification information obtaining and clustering operation shown in FIG. 16. FIGS. 18 to 21 are exemplary views related to the clustering operation of FIG. 17. FIG. 22 is an exemplary view of rectified images provided according to an image rectification method of the present disclosure.

Referring to FIG. 16, the image rectification method according to an embodiment of the present disclosure may include operation S500 of estimating a distortion characteristic for each pixel (or cell) of an input image and operation S510 of obtaining rectification information based on the estimated distortion characteristic and clustering pixels (or cells).

Operations S500 and S510 will be described in more detail with reference to FIGS. 17 to 21 below.

Referring to FIG. 17, operation S500 of estimating a distortion characteristic for each pixel (or cell) of an input image may include operation S502 of dividing the input image into a plurality of cells and operation S504 of estimating a rectangle (distorted rectangle) representing a distortion characteristic of each divided cell. Operations S502 and S504 are substantially the same as operations S302 and S304 of FIG. 4, and specific embodiments have been described with reference to FIGS. 5 and 6.

Operation S510 of obtaining rectification information based on the estimated distortion characteristic may include operation S512 of calculating respective homography matrices for the plurality of cells based on the rectangle (distorted rectangle) and a rectified rectangle (reference rectangle) and operation S514 of clustering the plurality of cells based on similarity (or dissimilarity) of the homography matrices.

As described above in FIGS. 14 and 15, the homography matrix generation module 1422 may calculate a homography matrix based on a difference between a quadrangle representing an estimated distortion characteristic and the reference rectangle for each of a plurality of cells. The clustering module 1424 may classify (cluster) the cells into at least one cluster based on similarity (or dissimilarity) of respective homography matrices of the cells generated by the homography matrix generation module 1422.

Referring to FIG. 18, the clustering module 1424 may cluster cells with similar homography matrices for a plurality of cells included in an image 1800. For example, the image 1800 may have three areas with different distortion characteristics, and in this case, cells 1810 of the image 1800 may be divided into a first cluster 1811 including cells corresponding to a first area, a second cluster 1812 including cells corresponding to a second area, and a third cluster 1813 including cells corresponding to a third area.

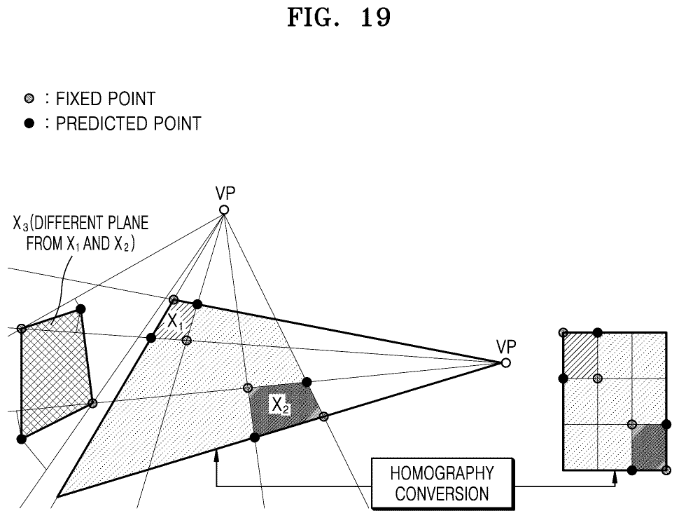

Hereinafter, a method in which the clustering module 1424 determines whether homography matrices are similar will be described in more detail with reference to FIGS. 19 to 21.

Referring to FIG. 19, when a first quadrangle x₁ representing a distortion characteristic of a first cell of an image and a second quadrangle x₂ representing a distortion characteristic of a second cell of the image exist on an identical plane, respective positions of vanishing points VP of the quadrangles may be the same. The vanishing point VP may include a horizontal vanishing point and a vertical vanishing point. In addition, when the first quadrangle x₁ and the second quadrangle x₂ exist on an identical plane, rectification may be performed on the two cells through homography conversion using the same homography matrix.

Based on this, the clustering module 1424 may measure dissimilarity between two quadrangles and cluster cells corresponding to quadrangles with low dissimilarity into the same cluster. For example, to calculate dissimilarity between the first quadrangle x₁ and the second quadrangle x₂, the clustering module 1424 may calculate positions of vanishing points VP of the first quadrangle x₁, and may calculate dissimilarity by calculating distances between straight lines connecting fixed vertices from among vertices of the second quadrangle x₂ and the vanishing points VP of the first quadrangle x₁ and estimated vertices. The closer the sum of the calculated distances is to 0, the lower the dissimilarity (higher the similarity), and the greater the sum of the distances, the higher the dissimilarity. According to an example of FIG. 19, the sum of distances calculated for the second quadrangle x₂ may correspond to 0. In this case, the clustering module 1424 may determine that the first quadrangle x₁ and the second quadrangle x₂ have the same homography matrix, and may cluster the first cell corresponding to the first quadrangle x₁ and the second cell corresponding to the second quadrangle x₂ into an identical cluster. However, the sum of distances calculated for a third quadrangle x₃ may have a value much greater than 0. In this case, the clustering module 1424 may determine that the first quadrangle x₁ and the third quadrangle x₃ have different homography matrices, and may cluster a third cell corresponding to the third quadrangle x₃ into a different cluster from the first cell.

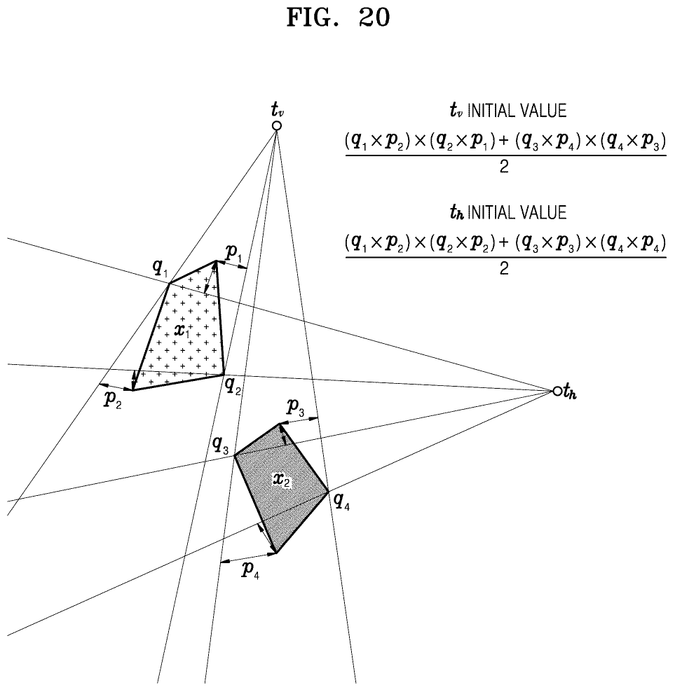

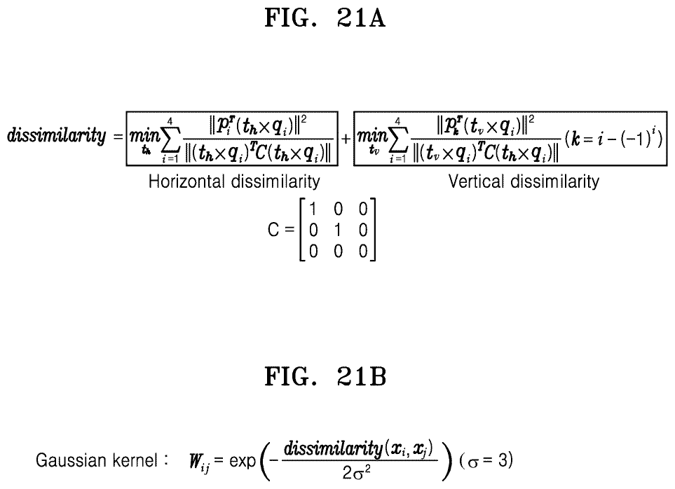

Referring to embodiments of FIGS. 20 and 21, the clustering module 1424, using dissimilarity designed based on a property that vanishing points are at the same position when two quadrangles showing distortion characteristics exist on an identical plane, may generate a similarity matrix between pairs of cells (or pixels) in an image and perform clustering using the generated similarity matrix.

In more detail, the clustering module 1424 may calculate a horizontal point tₕ and a vertical point tᵥ according to the formula shown in FIG. 20. The points tₕ and tᵥ may correspond to points that minimize the sum of the quadrangle of a distance between pi and a straight line connecting tₕ and qᵢ and the square of a distance between pₖ and a straight line connecting tᵥ and qᵢ (i and k are natural numbers, respectively). The clustering module 1424 may calculate dissimilarity based on the calculated points tₕ and tᵥ and vertex coordinates of the quadrangles. The dissimilarity may be calculated using the equation shown in FIG. 21A, but is not limited thereto.

The clustering module 1424 may calculate dissimilarity for all pairs of cells (or pixels), generate a distance matrix (xᵢ, xⱼ) including a calculation result for each of the pairs, and generate a similarity matrix (Wᵢⱼ) by applying a Gaussian kernel shown in FIG. 21B to the generated distance matrix. The clustering module 1424 may classify cells (pixels) of the image into at least one cluster based on the generated similarity matrix.

Referring again to FIG. 17, operation S510 may include operation S516 of estimating reliability of each cluster and operation S518 of generating a representative homography matrix for each of clusters to perform rectification based on the estimated reliability. According to an embodiment, operation S516 may be omitted.

By estimating reliability of a calculated homography matrix, the reliability estimation module 1426 may distinguish between clusters for which rectification will be performed and clusters for which rectification will not be performed. The reliability estimation operation of the reliability estimation module 1426 has been described in detail in FIGS. 8A and 8B and elsewhere.

The representative homography matrix generation module for each cluster 1428 may generate a representative homography matrix for each of the clusters classified into clusters to perform rectification according to a result of the reliability estimation. For example, the representative homography matrix generation module for each cluster 1428 may generate the representative homography matrix based on an average value, mode, median, etc. of homography matrices of cells in a cluster, but is not limited thereto.

FIG. 16 will be described again.

The image rectification method may include operation S520 of providing a rectified image for each cluster based on obtained rectification information.

Referring to FIG. 22 together, the image conversion module 1430 may provide a rectified image by performing homography conversion on the image 20 based on a representative homography matrix generated for a cluster for which rectification is to be performed from among clusters in the image 20.

According to an embodiment, when there are multiple clusters for which rectification is to be performed, there may also be multiple representative homography matrices. In this case, the image conversion module 132 may provide the rectified images 31 and 32 based on each cluster by performing homography conversion on the image 20 multiple times using each of the multiple representative homography matrices.

In more detail, when there is a first cluster 21 and a second cluster 22 for which rectification is to be performed in the image 20, the image conversion module 132 may provide the rectified first image 31 through homography conversion based on a representative homography matrix of the first cluster 21. Looking at the first image 31, it can be seen that an area corresponding to the first cluster 21 has been smoothed. In addition, the image conversion module 132 may provide the rectified second image 32 through homography conversion based on a representative homography matrix of the second cluster 22. Looking at the second image 32, it can be seen that an area corresponding to the second cluster 22 has been smoothed.

According to embodiments of the present disclosure, the image rectification system 1400 clusters pixels with similar distortion characteristics and provides rectified images based on each cluster, thereby providing a smooth and efficient rectification function even when various distortion characteristics exist in an image.

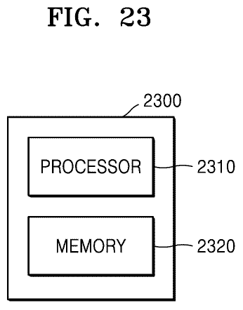

FIG. 23 is a schematic block diagram of a device performing an image rectification method, according to an example embodiment of the present disclosure.

Referring to FIG. 23, a device 2300 according to an embodiment of the present disclosure may correspond to any one of at least one computing device constituting the image rectification systems 100 and 1400 described above in FIGS. 1 and/or 14. In this case, the device 2300 may be a device that performs operations of estimating a distortion characteristic of the image described above in this specification, obtaining rectification information based on the estimated distortion characteristic, and providing an image rectified based on the rectification information. In addition, the device 2300 may correspond to a device that performs operations of obtaining rectification information and clustering based on an estimated distortion characteristic, and providing rectified images based on each cluster.

The device 2300 may include a processor 2310 and a memory 2320. However, components of the device 2300 are not limited to the examples described above. For example, the device 2300 may include more or fewer components than the components described above. In addition, there may be at least one processor 2310 and there may be at least one memory 2320. In addition, two or more of the processor 2310 and the memory 2320 may be combined into one chip.

According to an embodiment, the processor 2310 may correspond to at least one of the distortion characteristic estimation modules 110 and 1410, the rectification information generation modules 120 and 1420, the image conversion modules 130 and 1430, and the learning modules 150 and 1450 described above, or may execute or control at least one of the above components.

The processor 2310 may include hardware such as a central processing unit (CPU), an application processor (AP), an integrated circuit, a microcomputer, an application specific integrated circuit (ASIC), a field programmable gate array (FPGA), and/or a neural processing unit (NPU).

According to an embodiment, the memory 2320 may store programs and data necessary for the operations of the device 2300.

In addition, the memory 2320 may store at least one of data generated or obtained through the processor 2310. According to an embodiment, the memory 2320 may store data, instructions, algorithms, etc. related to the characteristic estimation modules 110 and 1410, the rectification information generation modules 120 and 1420, the image conversion modules 130 and 1430, and/or learning modules 150 and 1450. In addition, the memory 720 may be understood as a concept that includes the databases 140 and 1440 of FIGS. 1 and/or 14.

The memory 2320 may be composed of a storage medium such as ROM, RAM, flash memory, SSD, or HDD, or a combination of storage media.

While the present disclosure has been particularly shown and described with reference to embodiments thereof, it will be understood that various changes in form and details may be made therein without departing from the spirit and scope of the following claims.

In addition, it will be apparent to one of ordinary skill in the art that various changes and modifications are possible within a range that does not deviate from the basic principles of the present disclosure.

1. An image rectification system comprising:
a distortion characteristic estimation module configured to divide an input image into a plurality of cells and estimate a distortion characteristic of each of the plurality of divided cells;
a rectification information generation module configured to generate rectification information for each of the plurality of cells based on estimated distortion characteristic and reference information for rectification; and
an image conversion module configured to obtain a parameter for rectification for each of the plurality of cells and alignment of rectified cells based on the generated rectification information, and performing rectification on the input image based on the obtained parameter.

2. The image rectification system of claim 1, wherein the distortion characteristic estimation module comprises:
for each of the plurality of divided cells, a deep learning-based network trained to estimate a polygon representing a distortion characteristic of a cell with one pixel included in the cell as a center.

3. The image rectification system of claim 2, wherein the reference information comprises vertex coordinates of a reference polygon corresponding to a state in which no distortion exists, and
the rectification information generation module generates the rectification information based on a difference between vertex coordinates of the polygon estimated for each of the plurality of cells and the vertex coordinates of the reference polygon.

4. The image rectification system of claim 3, wherein the rectification information generation module is configured to:
when there is information about a focus position of the input image, obtain vertex coordinates of a reference polygon to which an aspect ratio calculated based on the focus position is applied; and
generate the rectification information based on a difference between the vertex coordinates of the polygon estimated for each of the plurality of cells and the vertex coordinates of the reference polygon to which the aspect ratio is applied.

5. The image rectification system of claim 3, wherein the rectification information generation module is configured to:
estimate reliability based on a tilt difference between a first side of a first polygon estimated for a first cell from among the plurality of cells and a second side corresponding to the first side from among sides of a second polygon estimated for a second cell corresponding to the first cell from among images obtained by rotating the input image by a preset angle; and
determine the first cell as a cell in which a rectification operation will be performed when the estimated reliability is greater than or equal to a reference value,
wherein the reliability is higher as the tilt difference is closer to the preset angle.

6. The image rectification system of claim 3, further comprising:
a database configured to store the vertex coordinates of the polygon estimated for each of the plurality of cells and the vertex coordinates of the reference polygon.

7. The image rectification system of claim 3, wherein the rectification information comprises a homography matrix, and
the image conversion module performs homography conversion on each of the plurality of cells based on a homography matrix of each of the plurality of cells.

8. The image rectification system of claim 7, wherein the image conversion module, for each of the plurality of homography-converted cells, calculates the parameter for aligning the plurality of cells by deforming the plurality of cells so that adjacent sides contact each other,
wherein the parameter comprises a value indicating a position to be moved for rectification of each of pixels of the cells of the input image.

9. The image rectification system of claim 8, wherein the image conversion module performs rectification on the input image through barycentric conversion using the parameter.

10. The image rectification system of claim 9, wherein the image conversion module performs low rank texture conversion on a rectified image.

11. An image rectification method comprising:
dividing an input image into a plurality of cells and estimating a distortion characteristic for each of the plurality of divided cells;
generating rectification information for each of the plurality of cells based on estimated distortion characteristic and reference information for rectification;
obtaining a parameter for rectification for each of the plurality of cells and alignment of rectified cells based on the generated rectification information; and
performing rectification on the input image based on the obtained parameter.

12. The image rectification method of claim 11, wherein the estimating of a distortion characteristic comprises:
for each of the plurality of cells, estimating a polygon representing a distortion characteristic of a cell with one pixel included in the cell as a center.

13. The image rectification method of claim 12, wherein the reference information comprises vertex coordinates of a reference polygon corresponding to a state in which no distortion exists, and
the generating of rectification information comprises:
generating the rectification information based on a difference between vertex coordinates of the polygon estimated for each of the plurality of cells and the vertex coordinates of the reference polygon.

14. The image rectification method of claim 13, wherein the generating of rectification information comprises:
when there is information about a focus position of the input image, obtaining vertex coordinates of a reference polygon to which an aspect ratio calculated based on the focus position is applied; and
generating the rectification information based on a difference between the vertex coordinates of the polygon estimated for each of the plurality of cells and the vertex coordinates of the reference polygon to which the aspect ratio is applied.

15. The image rectification method of claim 13, wherein the rectification information comprises a homography matrix, and
the obtaining of a parameter comprises:
performing homography conversion on each of the plurality of cells based on a homography matrix of each of the plurality of cells; and,
for each of the plurality of homography-converted cells, obtaining the parameter for aligning the plurality of cells by deforming the plurality of cells so that adjacent sides contact each other,
wherein the parameter comprises a value indicating a position to be moved for rectification of each of pixels of the cells of the input image.

16. The image rectification method of claim 11, wherein the performing of rectification comprises:
performing rectification on the input image through barycentric conversion using the parameter; and
performing low rank texture conversion on a rectified image.
